(19) United States
(12) Patent Application Publication
(10) Pub. No.: US 2016/0338810 A1
(43) Pub. Date: Nov. 24, 2016

(54) FLUID DISTRIBUTION DEVICE FOR A PERSONAL CARE APPLIANCE

(71) Applicant: KONINKLIJKE PHILIPS N.V., Eindhoven (NL)

(72) Inventors: LISA BETHANY SCHMALHURST, ISSAQUAH, WA (US); GERTRUDE RIETTE VAN DER KAMP, GRONINGEN (NL); KEVIN ARNOLD MILLER, BELLVUE, WA (US)

(21) Appl. No.: 15/108,356

(22) PCT Filed: Dec. 20, 2014
(86) PCT No.: PCT/IB2014/067184

§ 371 Date: Jun. 27, 2016

Related U.S. Application Data
(60) Provisional application No. 61/921,572, filed on Dec. 30, 2013.

(51) Int. Cl. A61C 17/22; A46B 9/04; A46B 11/00

(52) U.S. Cl. CPC A61C 17/228; A46B 11/002; A46B 9/045; A61C 17/221

(57) ABSTRACT

A flowable medium distribution device (10) comprises a chamber (12), a distribution member (30), a dispensing membrane (24,40,68,72) and bristles (36). The chamber (12) is configured to contain the flowable medium (62). The distribution member (30) includes an aspect (32,34) from which the flowable medium is to be dispensed. The dispensing membrane (24,40,68,72) is disposed on the aspect of the distribution member for dispensing the flowable medium on at least one surface to be treated. The dispensing membrane comprises a plurality of uni-directional dispensing outlets (26,46,70,74), operable between (a) normally-closed and (b) open positions. The bristles (36) extend from the dispensing membrane and are for contacting with the surface to be treated. The dispensing membrane (i) dispenses the flowable medium through the plurality of unidirectional dispensing outlets only in response to application of a differential pressure across the dispensing membrane equal to or exceeding a threshold, wherein the uni-directional dispensing outlets open for delivery of the flowable medium, and (ii) responsive to the differential pressure across the dispensing membrane being less than the threshold, the uni-directional dispensing outlets return to a normally-closed position which terminates delivery of the flowable medium (62).

The present embodiments relate generally to personal care appliances and more particularly to a fluid distribution device for dispensing a flowable medium onto a surface to be treated.

In one prior art teeth-cleaning mouthpiece for brushing teeth, the mouthpiece includes a body having portions configured to receive a user's upper and lower sets of teeth when it is inserted into the user's mouth. Teeth cleaning assemblies of the mouthpiece are mounted in the receiving portions which include bristles for cleaning of the teeth and a system for moving the bristles against the teeth to scrub and clean the teeth. In one embodiment, bellows elements are positioned adjacent to surfaces of the teeth-receiving portions of the mouthpiece. Bristles are attached to the respective bellows element. A pump is used to change a pressure in the bellows elements which results in movement of the bellows toward and away from the teeth. As a result, the bristles attached to a respective bellows element also move against the teeth and then away from the teeth, resulting in cleansing of the teeth by a scrubbing-type action. However, such a teeth-cleaning mouthpiece suffers from insufficient and/or inadequate fluid distribution and dispensing of a flowable medium onto the surface to be treated.

Dispersion techniques are known for applying toothpaste to a brushing mouthpiece. Such dispersion techniques can include squeezing a traditional tube and/or using a foaming device to decrease the viscosity of the toothpaste. However, the known dispersion techniques can disadvantageously result in an inconsistent application of toothpaste, either with respect to an amount or a location. The later circumstance could ultimately affect the efficacy of the brushing mouthpiece. In addition, the known dispersion techniques also lead to consumer dissatisfaction.

Accordingly, an improved method and apparatus for overcoming the problems in the art is desired.

In accordance with one aspect, a flowable medium distribution device for a personal care appliance comprises a chamber, a distribution member, a dispensing membrane and a plurality of bristles. The chamber is configured to contain the flowable medium, the chamber having an inlet and an outlet. The distribution member is coupled to the outlet of the chamber for receiving the flowable medium and includes at least one aspect from which the flowable medium is to be dispensed. The dispensing membrane is disposed on the at least one aspect of the distribution member for dispensing the flowable medium on at least one surface to be treated. The dispensing membrane comprises a plurality of uni-directional dispensing outlets, operable between (a) normally-closed and (b) open positions. The plurality of bristles extend from the dispensing membrane and are for contacting with the at least one surface to be treated. The dispensing membrane (i) dispenses the flowable medium through the plurality of uni-directional dispensing outlets only in response to application of a differential pressure across the dispensing membrane equal to or exceeding a threshold differential pressure across the dispensing membrane, wherein the uni-directional dispensing outlets open for delivery of the flowable medium through the dispensing membrane, and (ii) responsive to the differential pressure across the dispensing membrane being less than the threshold differential pressure across the dispensing membrane, the uni-directional dispensing outlets return to a normally-closed position which terminates delivery of the flowable medium through the dispensing membrane.

Still further advantages and benefits will become apparent to those of ordinary skill in the art upon reading and understanding the following detailed description.

The embodiments of the present disclosure may take form in various components and arrangements of components, and in various steps and arrangements of steps. Accordingly, the drawings are for purposes of illustrating the various embodiments and are not to be construed as limiting the embodiments. In the drawing figures, like reference numerals refer to like elements. In addition, it is to be noted that the figures may not be drawn to scale.

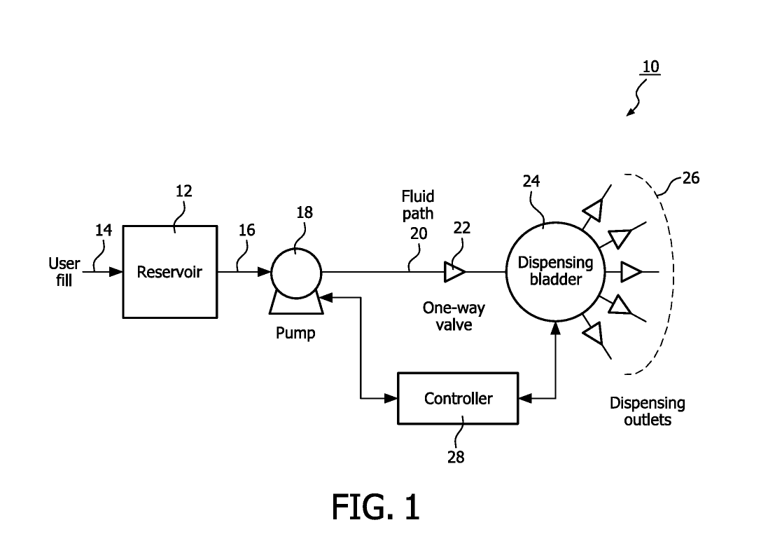

FIG. 1 is an overall schematic block diagram view of a flowable medium distribution device according to an embodiment of the present disclosure;

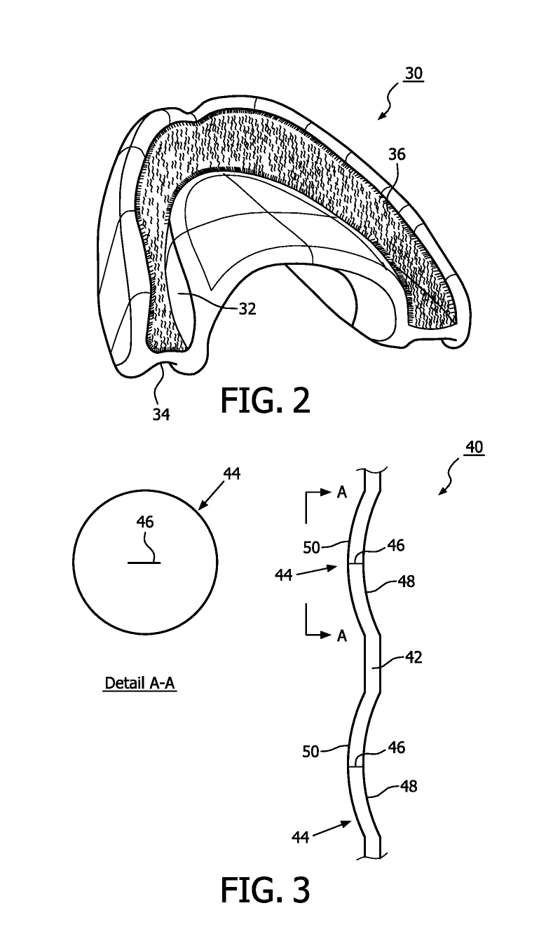

FIG. 2 is a perspective view of a mouthpiece incorporating the flowable medium distribution device according to one embodiment of the present disclosure;

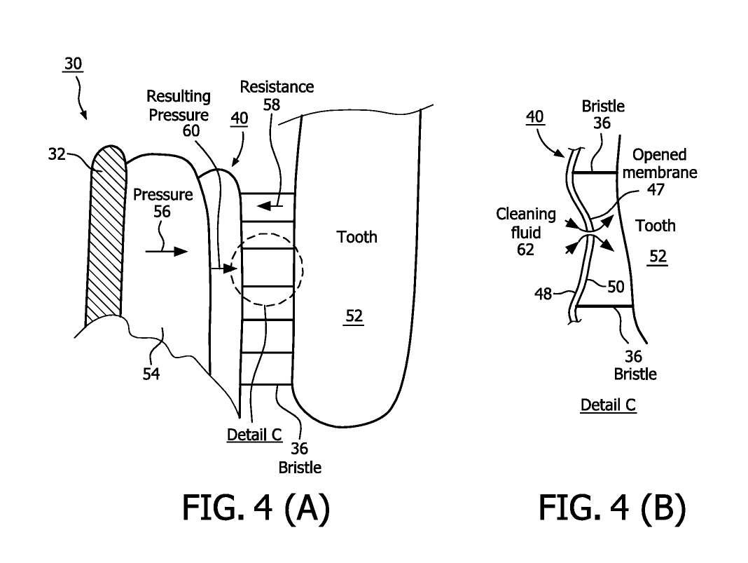

FIG. 3 is a schematic diagram view of a dispensing membrane of the flowable medium distribution device according to another embodiment of the present disclosure;

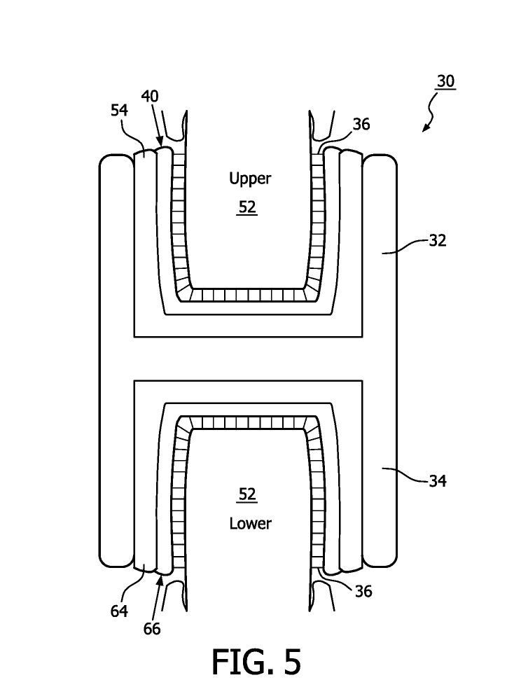

FIG. 4 ((A),(B)) is a side perspective view of a portion of the flowable medium distribution device according to another embodiment of the present disclosure;

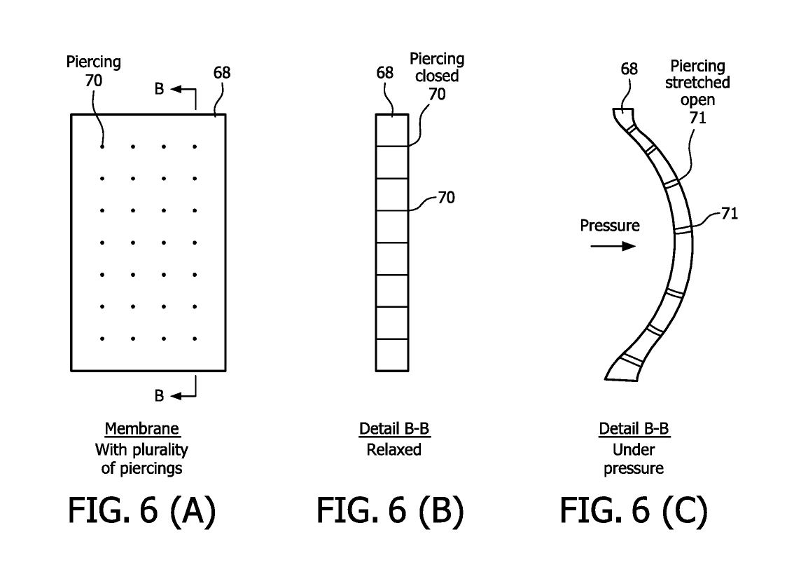

FIG. 5 is a cross-sectional view of a mouthpiece distribution member with top and bottom aspects incorporating the flowable medium distribution device according to yet another embodiment of the present disclosure;

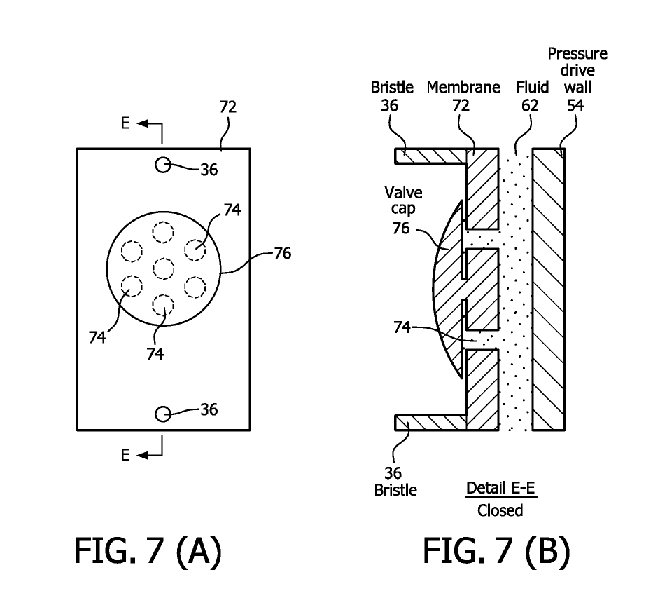

FIG. 6 ((A) front-view, (B) side-view relaxed, and (C) side-view under pressure) is an illustrative view of a dispensing membrane, featuring a plurality of dispensing outlets, of the flowable medium distribution device according to one embodiment of the present disclosure; and

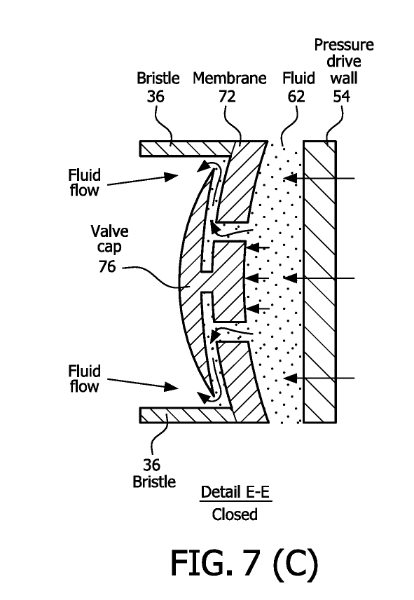

FIG. 7 ((A) front-view, (B) side-view, normally-closed, and (C) side-view, open) is an illustrative view of a dispensing membrane, featuring a plurality of dispensing outlets, of the flowable medium distribution device according to another embodiment of the present disclosure.

The embodiments of the present disclosure and the various features and advantageous details thereof are explained more fully with reference to the non-limiting examples that are described and/or illustrated in the drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the present disclosure. The examples used herein are intended merely to facilitate an understanding of ways in which the embodiments of the present may be practiced and to further enable those of skill in the art to practice the same. Accordingly, the examples herein should not be construed as limiting the scope of the embodiments of the present disclosure, which is defined solely by the appended claims and applicable law.

It is understood that the embodiments of the present disclosure are not limited to the particular methodology, protocols, devices, apparatus, materials, applications, etc., described herein, as these may vary. It is also to be understood that the terminology used herein is used for the purpose of describing particular embodiments only, and is not intended to be limiting in scope of the embodiments as claimed. It must be noted that as used herein and in the appended claims, the singular forms “a,” “an,” and “the” include plural reference unless the context clearly dictates otherwise.

Unless defined otherwise, all technical and scientific terms used herein have the same meanings as commonly understood by one of ordinary skill in the art to which the embodiments of the present disclosure belong. Preferred methods, devices, and materials are described, although any methods and materials similar or equivalent to those described herein can be used in the practice or testing of the embodiments.

According to one embodiment as disclosed herein, a contained chamber includes a one-way permeable membrane for the distribution of fluid to be used in connection with a brushing mouthpiece or other personal care appliance, such as an electric shaver. For example, a chamber with one-way permeable membrane can advantageously hold and allow for dispersion of fluid, i.e., toothpaste, mouthwash, therapeutic agent, whitening agent, shaving lubricant, etc. In particular, with respect to fluid dispersion in a user's mouth, the embodiments of the present disclosure advantageously provide for less spilling of fluid (i.e., compared to applying a paste or fluid to exterior surfaces of a known mouthpiece prior to inserting the mouthpiece into the user's mouth, especially since the lower portion of the known mouthpiece would be placed facing downward onto the user's lower teeth). Also, with respect to the embodiments of the present disclosure, in the case of a pressure driven brushing mouthpiece, distribution of the fluid can accomplished by using a pulsatile flow of a pressure drive in the mouthpiece, as will be discussed further herein. In the case of a displacement driven mouthpiece, an alternate means of creating pressure for dispensing the toothpaste is used. Accordingly, the chamber and one-way permeable membrane advantageously delivers fluid to the whole of the mouth, insuring relatively even distribution of the fluid to all surfaces of the teeth/gums, as appropriate for a given treatment process and/or implementation.

In one embodiment, the flowable medium distribution device of the present disclosure advantageously address how a consumer can apply toothpaste using a brushing mouthpiece device, which has both top and bottom aspects. Accordingly, the embodiment facilitates for the consumer an ease in the use of a brushing mouthpiece.

The embodiments of the flowable medium distribution device of the present disclosure further advantageously improve customer satisfaction with a brushing mouthpiece insomuch as the flowable medium distribution device enables a brushing mouthpiece such that any suitable fluid may be used. The flowable medium distribution device also does not require particular toothpaste or other fluid in that it is designed to accommodate a variety of amounts of fluid viscosities. The flowable medium distribution device of the present disclosure also enables a further expansion of a brushing mouthpiece to be used as a delivery device for a therapeutic agent, chemical whitening agent, or other treatment agent.

As disclosed herein, in one embodiment, the flowable medium distribution device includes a one-way porous flexible membrane. The one-way porous flexible membrane is designed and manufactured of an elastomeric such that when a certain amount of positive pressure is emitted on the internal surface of the membrane, fluid agent is delivered through a number of pores in the membrane. However, once the pressure is removed, the pores close shut. In this way, a particular dosage of the fluid can advantageously be pre-determined and designed into the membrane. In addition, the pores and the device are designed such that they cover the plurality of surfaces to be cleaned/treated in the mouth (e.g., buccal, lingual and occlusal surfaces of the teeth).

In another embodiment, a chamber is configured as a fill-and-go chamber or a chamber attachable to an external tube, bottle or other container, as determined according to the particular requirements of a given implementation, and/or as defined by consumer needs. In one embodiment, the chamber includes a one-way permeable membrane, which is either in intimate contact with, or defines, an internal surface of the brushing mouthpiece.

With reference now to FIG. 1, there is shown an overall schematic block diagram view of a flowable medium distribution device 10 according to an embodiment of the present disclosure. The flowable medium distribution device 10 includes a chamber or reservoir 12 having an inlet 14 and an outlet 16, wherein the chamber is configured to contain a flowable medium, e.g., toothpaste. In one embodiment, the chamber comprises a user-fillable chamber (e.g., fill and go). In addition, the inlet 14 of the chamber 12 can comprise, for example, a suitable port configured for coupling or attaching the chamber to an external supply or container of a flowable medium or fluid.

Coupled to the output of chamber 12, via outlet 16, is a pump 18. Pump 18 comprises any suitable pump configured for pumping a fluid from the reservoir, as needed, further according to the requirements of a particular surface treatment implemented via the flowable medium distribution device 10. Fluid pumped via pump 18 travels along a fluid path 20, through a one-way valve 22, and into a dispensing bladder 24. Dispensing bladder includes a plurality of one-way dispensing outlets, generally indicated by reference numeral 26. In addition, the flowable medium distribution device 10 further includes a controller 28. Controller 28 is coupled to the pump 18 and dispensing bladder, as appropriate, according to the requirements of a given flowable medium distribution device implementation. Controller 28 comprises any suitably programmed processor, microcontroller, or the like, and with instructions, embodied on a non-transitory computer-readable medium, for carrying out one or more operations of the flowable medium distribution device.

With reference now to FIG. 2, there is shown a perspective view of a mouthpiece 30 incorporating the flowable medium distribution device 10 according to one embodiment of the present disclosure. Mouthpiece 30 is generally configured to fit conveniently within the mouth of the user. Mouthpiece 30 includes upper and lower aspects, i.e., teeth-receiving portions, 32 and 34, which are configured, respectively, to receive all the teeth in both the upper and lower jaws. However, it should be understood that other embodiments could have configurations which receive only a portion of the teeth within the mouth, such as just the front and adjacent teeth on the upper and/or lower jaws, or other regions. Positioned within the teeth-receiving portions are one or more embodiments of the flowable medium distribution device 10, as discussed further herein with respect to the various Figures and accompanying description. For example, in one embodiment, the flowable medium distribution device 10 includes a bristle field or bristles 36, which can include conventional bristles, wherein the bristles can be any one of a variety of available bristles, including, for instance, nylon bristles of appropriate length and diameter for the mouthpiece 30. The bristles 36 are generally arranged and configured, as appropriate, as will be discussed further herein below.

In one embodiment, the dispensing bladder 24 is in the form of a distribution member coupled to the outlet of the chamber 12 for receiving the flowable medium, and having at least one aspect from which the flowable medium is to be dispensed. The distribution member comprises the mouthpiece 30. In one embodiment, the mouthpiece 30 includes top and bottom aspects, wherein the top aspect 32 is configured for receiving an upper set of user's teeth and the bottom aspect 34 is configured for receiving a lower set of user's teeth in response to the mouthpiece being inserted into the user's mouth. In addition, at least one of the top and bottom aspects, 32 and 34, include a bristle field 36. In another embodiment, both top and bottom aspects, 32 and 34, include a respective bristle field. Furthermore, the mouthpiece 30 may further comprise at least one of (i) a pressure driven brushing mouthpiece, (ii) a displacement driven brushing mouthpiece, and (iii) any combination thereof, as will be discussed further herein.

FIG. 3 is a schematic diagram view of a dispensing membrane 40 of the flowable medium distribution device 10 according to another embodiment of the present disclosure. The dispensing membrane 40 is disposed, for example, on the at least one aspect (32 and/or 34) of the distribution member (i.e., mouthpiece 30) for contact with at least one treatment surface. The dispensing membrane 40 comprises a plurality of uni-directional, normally-closed, dispensing outlets 26 extending from an internal surface to an external surface of the dispensing membrane 40. As shown in FIG. 3, only a portion of dispensing membrane 40 is shown. Membrane 40 comprises a flexible membrane 42 having a plurality of dome shaped features or domes 44 formed within the membrane 42 and extending above a principal axis or plane of the membrane. Each of the domes 44 includes a slit 46. Each slit 46 comprises a uni-directional, normally-closed, dispensing outlets extending from an internal surface 48 to an external surface 50 of the dispensing membrane 40. As discussed herein, the dispensing membrane dispenses the flowable medium through the plurality of dispensing outlets (i.e., slits 46) only in response to application of a differential pressure across the dispensing membrane equal to or exceeding a threshold differential pressure. In other words, in response to a differential pressure equal to or greater than the threshold differential pressure across the dispensing membrane, the uni-directional, normally-closed, dispensing outlets (i.e., slits 46) open for delivery of the flowable medium through the dispensing membrane. Responsive to the differential pressure across the dispensing membrane being less than the threshold differential pressure amount across the dispensing membrane, the uni-directional, normally-closed, dispensing outlets (i.e., slits 46) return to a normally-closed position which terminates delivery of the flowable medium through the dispensing membrane. Sizes and spacing of and between adjacent domes 44 and slits 46 are determined according to the requirements of a given flowable medium distribution device implementation.

Referring now to FIG. 4, there is shown a side perspective view FIG. 4 (A) of a portion of the flowable medium distribution device according to another embodiment of the present disclosure. In addition, there is shown a portion of the membrane thereof in greater detail, FIG. 4 (B). In FIG. 4, a portion of a user's tooth 52 is shown engaging bristles of the bristle field 36. As illustrated, the first aspect or upper teeth-receiving portion 32 of mouthpiece 30 which includes a pressure drive portion 54 in the form of a bellows element positioned adjacent a surface of the teeth-receiving portion 32 of the mouthpiece 30. Pressure, as indicated by the arrow and reference numeral in the bellows element 54 can be controlled in some embodiments, via controller 28 and a suitable pump (not shown) coupled to the bellows element for providing a positive internal pressure or a negative internal pressure within the bellows element, as appropriate, for a given implementation. Changing the internal pressure within the bellows element results in movement of a surface of the bellows element towards the tooth 52 (i.e., via a positive applied internal pressure) and away from (i.e., via a negative applied internal pressure) the tooth 52. An example of a bellows element and pump arrangement is disclosed in commonly assigned U.S. Patent Application Publication 2011/0072605 A1, entitled “MOUTHPIECE FOR BRUSHING TEETH,” by Jelte Steur, incorporated herein by reference, in its entirety. In other embodiments, an internal pressure with the bellows element 54 comprises a fixed internal pressure configured for a given implementation.

Coupled to the bellows element 54 is membrane 40 in the form of a dispensing bladder upon which bristles 36 are attached. Preferably, bristles are attached to the outer surface 50 of membrane 40 about respective ones of the uni-directional, normally-closed, dispensing outlets (i.e., slits 46). In one embodiment, in preparation for application of the flowable medium to the at least one treatment surface, an interior volume enclosed by the membrane 40 is filled with the flowable medium, for example, via pump 18 and one-way valve 22 (FIG. 1). In response to a surface (e.g., a pressure drive wall) of the bellows element 54 moving towards the tooth 52, and the bristles 36 also moving towards and making contact against the tooth 52 (or teeth), the bristles 36 operate to produce a resistance 58 (or pressure) in a direction opposite to the pressure 56. A resulting pressure 60 (i.e., differential pressure) is produced within the dispensing bladder, and thus on an inside surface 48 of membrane 40. In response to a differential pressure 60 equal to or greater than the threshold differential pressure across the dispensing membrane, the uni-directional, normally-closed, dispensing outlets (i.e., slits 46) open, (as illustrated by reference numeral 47 in FIG. 4 (B)) for delivery of the flowable medium (e.g., cleaning fluid 62) through the dispensing membrane. Responsive to the differential pressure across the dispensing membrane being less than the threshold differential pressure amount across the dispensing membrane, the uni-directional, normally-closed, dispensing outlets (i.e., slits 46) return to a normally-closed position which terminates delivery of the flowable medium through the dispensing membrane.

FIG. 5 is a cross-sectional view of a mouthpiece distribution member 30 with top and bottom aspects, 32 and 34, respectively, incorporating the flowable medium distribution device according to yet another embodiment of the present disclosure. As discussed herein above with reference to FIG. 4, the mouthpiece 30 includes a first pressure drive portion 54 in the form of a bellows element located between the top aspect 32 and the dispensing bladder formed of membrane 40. Similarly, the mouthpiece 30 further includes a second pressure drive portion 64 in the form of a bellows element located between the bottom aspect 34 and the dispensing bladder formed of a membrane 66, similar to that of membrane 40. Operation of second pressure drive portion 64, membrane 66, and bristle field 36 is similar to that described above with respect to first pressure drive portion 54, dispensing membrane 40, and bristle field 36.

Turning now to FIG. 6, there is shown a front-view (A), side-view relaxed (B), and side-view under pressure (C) in an illustrative view of a dispensing membrane, featuring a plurality of dispensing outlets, of the flowable medium distribution device according to one embodiment of the present disclosure. The dispensing membrane 68 comprises an elastomeric membrane in which the plurality of dispensing outlets comprises a plurality of pores or piercings 70. The plurality of pores can provide dispersion or distribution coverage of the flowable medium to a plurality of surfaces to be cleaned/treated. Responsive to a differential pressure across the dispensing membrane being less than the threshold differential pressure amount across the dispensing membrane (i.e., relaxed), the uni-directional, normally-closed, dispensing outlets (i.e., piercings 70) are normally-closed or return to a normally-closed position. In the normally-closed position, delivery of the flowable medium through the dispensing membrane does not occur. In response to a differential pressure 72 equal to or greater than the threshold differential pressure across the dispensing membrane, the uni-directional, normally-closed, dispensing outlets (i.e., piercings 70) open, (as illustrated by reference numeral 71 in FIG. 6 (C)) for delivery of the flowable medium through the dispensing membrane 68.

Referring now to FIG. 7, there is shown a front-view (A), a side-view, of normally-closed dispensing outlets (B) and side-view, open dispensing outlets (C) in an illustrative view of a dispensing membrane, featuring a plurality of dispensing outlets, of the flowable medium distribution device according to another embodiment of the present disclosure. In the front-view (A), dispensing membrane 72 comprises a flexible membrane with a plurality of openings 74 with an overlying valve cap 76. The valve cap 76 has a dimension larger than the plurality of openings 74, such that responsive to a differential pressure across the dispensing membrane being less than the threshold differential pressure amount across the dispensing membrane (i.e., relaxed), the uni-directional, normally-closed, dispensing outlets (i.e., valve cap 76 and openings 74) are normally-closed or return to a normally-closed position. In the normally-closed position, delivery of the flowable medium through the dispensing membrane does not occur. In response to a differential pressure equal to or greater than the threshold differential pressure across the dispensing membrane 72, the uni-directional, normally-closed, dispensing outlets (i.e., valve cap 76 and openings 74) open, (as illustrated in FIG. 7 (C)) for delivery of the flowable medium 62 through the dispensing membrane 72. In one embodiment, the differential pressure across the dispensing membrane is generated by at least one of (i) a pump (18) and one-way valve (22) combination, (ii) a bellows element (54), and (iii) any combination thereof.

According to an embodiment of the present disclosure, a flowable medium distribution device for a personal care appliance comprises a chamber configured to contain a flowable medium, the chamber having an inlet and an outlet. A distribution member is coupled to the outlet of the chamber for receiving the flowable medium. The distribution member includes at least one aspect from which the flowable medium is to be dispensed. A dispensing membrane is disposed on the at least one aspect of the distribution member for dispensing the flowable medium on at least one surface to be treated. In one embodiment, the dispensing membrane comprises a plurality of uni-directional dispensing outlets, operable between (a) normally-closed and (b) open positions, extending from an internal surface to an external surface of the dispensing membrane. In addition, a plurality of bristles 36, are coupled to and extending from the external surface of the dispensing membrane, for contacting with the at least one surface to be treated. The dispensing membrane dispenses the flowable medium through the plurality of dispensing outlets only in response to application of a differential pressure across the dispensing membrane equal to or exceeding a threshold differential pressure across the dispensing membrane, wherein the uni-directional dispensing outlets open for delivery of the flowable medium through the dispensing membrane. Responsive to the differential pressure across the dispensing membrane being less than the threshold differential pressure across the dispensing membrane, the uni-directional dispensing outlets return to a normally-closed position which terminates delivery of the flowable medium through the dispensing membrane.

In another embodiment, the distribution member comprises a mouthpiece that includes top and bottom aspects, wherein the top aspect is configured for receiving an upper set of user's teeth and the bottom aspect is configured for receiving a lower set of user's teeth in response to the mouthpiece being inserted into a user's mouth. In another embodiment, at least one of the top and bottom aspects include a bristle field of the plurality of bristles. In addition, the mouthpiece further comprises at least one of (i) a pressure driven brushing mouthpiece, (ii) a displacement driven brushing mouthpiece, and (iii) any combination thereof.

In a further embodiment, the dispensing membrane further comprises an elastomeric membrane, and wherein the plurality of dispensing outlets comprises a plurality of pores. Furthermore, in another embodiment, the plurality of pores provides a distribution coverage of the flowable medium to a plurality of surfaces to be treated. Still further, the plurality of surfaces can comprise at least one or more of buccal, lingual, and occlusal surfaces of a user's teeth.

In another embodiment, the chamber further comprises a user-fillable chamber and wherein the inlet of the chamber comprises a port configured for coupling the chamber to an external supply of the flowable medium. In a further embodiment, the chamber contains a pre-set dosage of the flowable medium to be administered to the surface to be treated via the dispensing membrane. Still further, the flowable medium can comprise a fluid having a viscosity value in a range of 2 to 10000 Cp (centipoise). For example, the flowable medium comprises one selected from the group consisting of a toothpaste, a mouthwash, a whitening agent, a therapeutic agent, and any combination thereof. Moreover, the dispensing of the flowable medium can further comprise dispensing a consistent flow of the flowable medium with respect at least one selected from the group consisting of (i) an amount, (ii) a location, and (iii) any combination of the amount and the location.

In a still further embodiment, the dispensing of the flowable medium can further comprise dispensing a flow of the flowable medium that comprises one selected from the group consisting of (i) a pressure driven flow, (ii) a displacement driven flow, and (iii) a combination of pressure driven and displacement driven flow. In another embodiment, a controller provides at least one selected from the group consisting of a pulsatile flow control signal, a displacement driven control signal, and any combination of both pulsatile flow and displacement driven control signals. Still further, the flow can comprise a pressure driven flow, and wherein the personal care appliance comprises a pressure driven brushing mouthpiece, further wherein distribution of the flowable medium is accomplished by using a pulsatile flow of a pressure drive in the brushing mouthpiece.

Yet still further, according to another embodiment, the flow can comprise a displacement driven flow, and wherein the personal care appliance comprises a displacement driven brushing mouthpiece, further wherein distribution of the flowable medium is accomplished by using a periodic displacement of the brushing mouthpiece which applies a force to distribute the flowable medium to surfaces of a user's teeth and/or gums. A flow rate of the flowable medium is further controlled by at least one selected from the group consisting of (i) an internal pressure supplied to the chamber, and (ii) an elasticity and/or structure of the dispensing membrane, to minimize any undesirable effects of viscosity variation among different flowable mediums.

In a further embodiment, a personal care appliance comprises a flowable medium distribution device as disclosed herein, wherein the personal care appliance comprises one selected from the group consisting of an electric toothbrush, an oral hygiene device, a tooth polishing device, an electric shaver, and any combination thereof. For example, the membrane with fluid could be placed on an electric shaver surrounding the shaver heads such that when the shaver is placed on the user's face, a pressure is applied to the membrane dispensing a shaving gel. Alternately, the membrane could be set-up with a geometry such that the membrane is only put under pressure when the motion of the shaver across the user's face has the membrane in the leading edge of the motion applying the shaving gel in front of the shaving heads.

According to another embodiment, a flowable medium distribution device for a personal care appliance, comprises: a user-fillable chamber configured to contain a flowable medium having a viscosity value in a range of 2 to 10000 Cp, wherein the chamber comprises an inlet and an outlet, wherein the inlet comprises a port configured for coupling the chamber to an external supply of the flowable medium; a distribution member coupled to the outlet of the chamber for receiving the flowable medium, and having at least one aspect from which the flowable medium is to be dispensed; a dispensing membrane disposed on the at least one aspect of the distribution member for dispensing the flowable medium on at least one surface to be treated, wherein the dispensing membrane comprises a plurality of uni-directional dispensing outlets, operable between (a) normally-closed and (b) open positions, extending from an internal surface to an external surface of the dispensing membrane; and a plurality of bristles, coupled to and extending from the external surface of the dispensing membrane, for contacting with the at least one surface to be treated, wherein (i) the dispensing membrane dispenses the flowable medium through the plurality of dispensing outlets only in response to application of a differential pressure across the dispensing membrane equal to or exceeding a threshold differential pressure across the dispensing membrane, wherein the uni-directional dispensing outlets open for delivery of the flowable medium through the dispensing membrane, and (ii) responsive to the differential pressure across the dispensing membrane being less than the threshold differential pressure across the dispensing membrane, the uni-directional dispensing outlets return to a normally-closed position which terminates delivery of the flowable medium through the dispensing membrane.

Although only a few exemplary embodiments have been described in detail above, those skilled in the art will readily appreciate that many modifications are possible in the exemplary embodiments without materially departing from the novel teachings and advantages of the embodiments of the present disclosure. For example, the embodiments of the present disclosure can be advantageously used in various personal care appliance applications which involve distribution of a flowable medium. In addition, the embodiments of the present disclosure could also use a pulsating pressure to mix various brushing fluids. That is, using a pulsating pressure below the threshold needed for opening the one-way valves of the dispensing membrane to release fluid, the pulsating pressure could advantageously mix two or more fluids (e.g., mouthwash and toothpaste), provided separately, within the dispensing member, interior to the dispensing membrane, prior to dispensing of the same via the dispensing membrane. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

In addition, any reference signs placed in parentheses in one or more claims shall not be construed as limiting the claims. The word “comprising” and “comprises,” and the like, does not exclude the presence of elements or steps other than those listed in any claim or the specification as a whole. The singular reference of an element does not exclude the plural references of such elements and vice-versa. One or more of the embodiments may be implemented by means of hardware comprising several distinct elements, and/or by means of a suitably programmed computer. In a device claim enumerating several means, several of these means may be embodied by one and the same item of hardware. The mere fact that certain measures are recited in mutually different dependent claims does not indicate that a combination of these measures cannot be used to an advantage.

1. A flowable medium distribution device for a personal care appliance, comprising:
a chamber configured to contain a flowable medium, the chamber having an inlet and an outlet;
a distribution member coupled to the outlet of the chamber for receiving the flowable medium, and having at least one aspect from which the flowable medium is to be dispensed;
a dispensing membrane disposed on the at least one aspect of the distribution member for dispensing the flowable medium on at least one surface to be treated, wherein the dispensing membrane comprises a plurality of uni-directional dispensing outlets, operable between (a) normally-closed and (b) open positions, extending from an internal surface to an external surface of the dispensing membrane; and
a plurality of bristles, coupled to and extending from the external surface of the dispensing membrane, for contacting with the at least one surface to be treated,
wherein (i) the dispensing membrane dispenses the flowable medium through the plurality of uni-directional dispensing outlets only in response to application of a differential pressure across the dispensing membrane equal to or exceeding a threshold differential pressure across the dispensing membrane, wherein the uni-directional dispensing outlets open for delivery of the flowable medium through the dispensing membrane, and (ii) responsive to the differential pressure across the dispensing membrane being less than the threshold differential pressure across the dispensing membrane, the uni-directional dispensing outlets return to a normally-closed position which terminates delivery of the flowable medium through the dispensing membrane.

2. The device of claim 1, wherein the distribution member comprises a mouthpiece that includes top and bottom aspects, wherein the top aspect is configured for receiving an upper set of user's teeth and the bottom aspect is configured for receiving a lower set of user's teeth in response to the mouthpiece being inserted into a user's mouth.

3. The device of claim 2, wherein at least one of the top and bottom aspects include a bristle field of the plurality of bristles.

4. The device of claim 2, wherein the mouthpiece further comprises at least one of (i) a pressure driven brushing mouthpiece, (ii) a displacement driven brushing mouthpiece, and (iii) any combination thereof.

5. The device of claim 1, wherein the dispensing membrane further comprises an elastomeric membrane, and wherein the plurality of uni-directional dispensing outlets comprise a plurality of pores.

6.-7. (canceled)

8. The device of claim 1, wherein the chamber further comprises a user-fillable chamber and wherein the inlet of the chamber comprises a port configured for coupling the chamber to an external supply of the flowable medium.

9. The device of claim 1, wherein chamber contains a pre-set dosage of the flowable medium to be administered to the surface to be treated via the dispensing membrane.

10. (canceled)

11. The device of claim 1, wherein the flowable medium comprises one selected from the group consisting of a toothpaste, a mouthwash, a whitening agent, a therapeutic agent, and any combination thereof.

12. The device of claim 1, wherein the dispensing of the flowable medium further comprises dispensing a consistent flow of the flowable medium with respect at least one selected from the group consisting of (i) an amount, (ii) a location, and (iii) any combination of the amount and the location.

13. The device of claim 1, wherein the differential pressure across the dispensing membrane is generated by at least one selected from the group consisting of (i) a pump and one-way valve combination, (ii) a bellows element, and (iii) any combination thereof.

14. The device of claim 1, wherein the dispensing of the flowable medium further comprises dispensing a flow of the flowable medium that comprises one selected from the group consisting of (i) a pressure driven flow, (ii) a displacement driven flow, and (iii) a combination of pressure driven and displacement driven flow.

15. The device of claim 14, further comprising:
a controller for providing at least one selected from the group consisting of a pulsatile flow control signal to a pump, a displacement driven control signal to a bellows element, and any combination of both pulsatile flow and displacement driven control signals.

16. The device of claim 15, further wherein the flow comprises a pressure driven flow, and wherein the personal care appliance comprises a pressure driven brushing mouthpiece, further wherein distribution of the flowable medium is accomplished by using a pulsatile flow of a pressure drive in the brushing mouthpiece.

17. The device of claim 15, further wherein the flow comprises a displacement driven flow, and wherein the personal care appliance comprises a displacement driven brushing mouthpiece, further wherein distribution of the flowable medium is accomplished by using a periodic displacement of the brushing mouthpiece which applies a force to distribute the flowable medium to surfaces of a user's teeth and/or gums.

18. The device of claim 1, wherein a flow rate of the flowable medium is further controlled by at least one selected from the group consisting of (i) an internal pressure supplied to the chamber, and (ii) an elasticity and/or structure of the dispensing membrane, to compensate for viscosity variation among different flowable mediums.

19.-20. (canceled)
